(19) United States
(12) Patent Application Publication
(10) Pub. No.: US 2014/0279411 A1
(43) Pub. Date: Sep. 18, 2014

(54) PRE-ARRANGING PAYMENT ASSOCIATED WITH MULTIPLE VENDORS WITHIN A GEOGRAPHIC AREA

(71) Applicant: BANK OF AMERICA COPORATION, Charlotte, NC (US)

(72) Inventors: Peter John Bertanzetti, Charlotte, NC (US); Laura Bondesen, Charlotte, NC (US); Matthew A. Calman, Charlotte, NC (US); David M. Grigg, Rock Hill, SC (US); Scott Lee Harkey, Concord, NC (US); Robert Scott Ellis, Aston, PA (US)

(73) Assignee: Bank of America Corporation, Charlotte, NC (US)

(21) Appl. No.: 13/804,636

(22) Filed: Mar. 14, 2013

(51) Int. Cl. G06Q 20/32

(52) U.S. Cl. CPC G06Q 20/3224
USPC 705/39

(57) ABSTRACT

Embodiments of the invention are directed to systems, methods and computer program products for enabling a user to execute at least one purchase transaction in a geographical area. An exemplary apparatus is configured to: receive identification information from a mobile device when a user associated with the mobile device enters a geographical area; receive geolocation information from the mobile device; receive payment preference information; determine, based on the geolocation information and the identification information, a purchase transaction being executed by a user of the mobile device in the geographical area; store transaction information associated with the purchase transaction; and process the transaction information, based on the payment preference information, upon determining the mobile device is exiting or has exited the geographical area.

### BACKGROUND

A user may visit a geographical area (e.g., a stadium, an arena, a cruise ship, a fair, a mail, or the like) where multiple merchants are located. There is a need to provide the user with an easy method of making purchases at multiple merchants in the geographical area.

### BRIEF SUMMARY

In some embodiments, an apparatus is provided for making a payment associated with at least one merchant in a geographical area. The apparatus comprises a memory; a processor; and a module stored in the memory, executable by the processor, and configured to: receive identification information from a mobile device when a user associated with the mobile device enters a geographical area; receive geolocation information from the mobile device; receive payment preference information; determine, based on the geolocation information and the identification information, a purchase transaction being executed by a user of the mobile device in the geographical area; store transaction information associated with the purchase transaction; and process the transaction information, based on the payment preference information, upon determining the mobile device is exiting or has exited the geographical area.

In some embodiments, the module is further configured to receive the payment preference information from the mobile device or from a database accessible based on the identification information.

In some embodiments, the module is further configured to: receive the payment preference information prior to, during, or after the mobile device enters the geographical area.

In some embodiments, the payment preference information comprises payment via at least one of a credit card, a debit card, a gift card, an electronic coupon, a prepaid card, or an electronic funds transfer.

In some embodiments, the geolocation information comprises a geographical location of the mobile device.

In some embodiments, the geolocation information comprises a network location of the mobile device.

In some embodiments, the identification information comprises a device code or readable indicia associated with the mobile device.

In some embodiments, the identification information comprises at least one of an image of the user, a fingerprint of the user, retinal information associated with the user, or biometric information associated with the user.

In some embodiments, the identification information is received via a wireless transmission mechanism.

In some embodiments, the geographical area comprises at least one merchant.

In some embodiments, the purchase transaction is executed at a merchant terminal.

In some embodiments, the identification information is displayed on the merchant terminal, and wherein the transaction information is associated with the identification information.

In some embodiments, an agent at the merchant terminal selects an option to confirm the identification information.

In some embodiments, the module is further configured to: receive the payment preference information from the mobile device or from a database accessible based on the identification information.

In some embodiments, the module is further configured to transmit an offer to the mobile device.

In some embodiments, the mobile device comprises at least one of a mobile phone, a portable computing device, a tablet, or a watch.

In some embodiments, the mobile device is configured to prompt a user to input an authentication credential in order to execute the purchase transaction.

In some embodiments, the module is further configured to prompt the user to provide permission to receive geolocation information from the mobile device.

In some embodiments, a method is provided for making a payment associated with at least one merchant in a geographical area. The method comprises: receiving identification information from a mobile device when the mobile device enters a geographical area; receiving geolocation information from the mobile device; receiving payment preference information; determining, based on the geolocation information and the identification information, a purchase transaction being executed by a user of the mobile device in the geographical area; storing transaction information associated with the purchase transaction; and processing the transaction information, based on the payment preference information, upon determining the mobile device is exiting or has exited the geographical area.

In some embodiments, a computer program product is provided for making a payment associated with at least one merchant in a geographical area. The computer program product comprises a non-transitory computer-readable medium comprising a set of codes for causing a computer to: receive identification information from a mobile device when a user associated with the mobile device enters a geographical area; receive geolocation information from the mobile device; receive payment preference information; determine, based on the geolocation information and the identification information, a purchase transaction being executed by a user of the mobile device in the geographical area; store transaction information associated with the purchase transaction; and process the transaction information, based on the payment preference information, upon determining the mobile device is exiting or has exited the geographical area.

### BRIEF DESCRIPTION OF THE DRAWINGS

Having thus described embodiments of the invention in general terms, reference will now be made to the accompanying drawings, where:

FIG. 1 is a flowchart illustrating a general process flow for making a payment associated with at least one merchant in a geographical area, in accordance with embodiments of the present invention; and

FIG. 2 is a block diagram illustrating technical components of a system for implementing the various processes described herein, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for making a payment associated with at least one merchant in a geographical area. The invention enables a user to visit a geographical area (e.g., a stadium, a mall, a cruise ship, an arena, a fair, or the like) and make purchase transactions at multiple merchants in the geographical area. The geographical area may be defined by a boundary. An apparatus (e.g., a server), located either within the geographical area or outside the geographical area, can monitor a geographical location or network location of a mobile device that is located in the geographical area. As used herein, a merchant may also be referred to as a vendor. The apparatus can monitor the location (e.g., geographical location, network location, or the like) of the mobile device with respect to a reference location (e.g., the location of the apparatus).

Referring now to FIG. 1, a general process flow 100 is provided for making a payment associated with at least one merchant in a geographical area. At block 110, the method comprises receiving identification information from a mobile device when the mobile device enters a geographical area. At block 120, the method comprises receiving geolocation information from the mobile device. At block 130, the method comprises receiving payment preference information. At block 140, the method comprises determining, based on the geolocation information and the identification information, a purchase transaction being executed by a user of the mobile device in the geographical area. At block 150, the method comprises storing transaction information associated with the purchase transaction. At block 160, the method comprises processing the transaction information upon determining the mobile device is exiting or has exited the geographical area. As used herein, geolocation information may also be referred to as location information, positioning information, position information, global positioning information, network location, or the like. Geolocation information associated with the user refers to geolocation information associated with the user's mobile device (e.g., mobile phone, tablet, watch, laptop, other portable computing device, or the like). As used herein, an apparatus may refer to a computing system. The computing system may be a check-in or check-out terminal at the geographical area, a merchant terminal in the geographical area, or a computing server located in or outside the geographical area.

When a user enters a geographical area, the user may be prompted to register the user's mobile device. Therefore, an apparatus (e.g., a check-in terminal) associated with the geographical area may receive (e.g., via a wireless transmission mechanism such as radio frequency or near-field communication) identification information from the mobile device during the registration process. The identification information may comprise at least one of an identification code (or other unique readable indicia that may be visual or non-visual) associated with the mobile device or identification information (e.g., an image of the user's face) associated with the user. In some embodiments, the identification information may be transmitted via touch (e.g., fingerprint of the user). In some embodiments, the identification information comprises retinal information or biometric information associated with the user. The identification information may be transmitted wirelessly (e.g., radio frequency or near-field communication) from the mobile device to the apparatus (e.g., the user may tap the mobile device on the apparatus or bring the mobile device in close proximity to the apparatus). Additionally, the user may permit the apparatus to track geolocation information associated with the mobile device. Therefore, the mobile device may periodically transmit the mobile device's geolocation information to the apparatus (or some other external apparatus) or the apparatus may periodically ping the mobile device for geolocation information.

Additionally, the user may input payment preference information onto the mobile device. For example, the user may specify a payment type (e.g., credit card, debit card, gift card, prepaid card, electronic funds transfer, or the like) to be used for purchases at merchants located in the geographical area. The user may specify different payment types to be used for different types of merchants (e.g., different merchant category codes). The user may specify the payment preference information either prior to or after entering the geographical area, but prior to making a purchase in the geographical area. The user may transmit the payment information input onto the mobile device to an apparatus in the geographical area or an external server or database. Therefore, in some embodiments, the apparatus receives the payment preference information from the user's mobile device. In other embodiments, the apparatus receives the payment preference information from an external server or database where the user's payment preference information is stored securely.

When the user is in the geographical area, the user may desire to make a purchase at a merchant in the geographical area. The user may approach the merchant's terminal. When the user is within a predetermined distance of the merchant's terminal, the merchant's agent (either human or virtual agent) may recognize the user based on identification information associated at least one of the mobile device (e.g., the mobile device identification code) or the user (e.g., the image of the user's face). Therefore, in some embodiments, when the user (with the user's mobile device) approaches the merchant's terminal, an image of the user's face appears on the merchant's terminal. The agent may select an option on the merchant's terminal to confirm that the user has been identified and input the products or services purchased by the user along with the purchase amounts (collectively referred to as the transaction information). The agent may then initiate transmission of the transaction information to the apparatus described herein. The apparatus stores the transaction information for a predetermined period.

When the user exits the geographical area, the user may go through a check-out process. For example, the user may tap (e.g., touch or bring in close proximity) the user's mobile device on a check-out terminal associated with the geographical area. By doing so, information may be transmitted wirelessly from the mobile device to the check-out terminal (e.g., geolocation information, payment preference information, or the like). The check-out terminal then communicates with the apparatus described herein to process the purchase transactions executed by the user in the geographical area. The purchase transactions are processed based on the payment preference information. For example, a user-selected payment method (e.g., a credit card) is applied to one or more of the purchase transactions. In some embodiments, the apparatus automatically detects that the user is exiting or has exited the geographical area (e.g., based on geolocation information associated with the user's mobile device). When the apparatus detects that the user has exited the geographical area, the apparatus initiates processing of the purchase transactions based on the payment preference information.

In some embodiments, an offer may be transmitted to the user when the user is in the geographical area. The offer may be associated with a merchant located in the geographical area. The user may activate the offer and make a purchase transaction at the merchant in the geographical area and earn a discount or rebate on the purchase transaction. In some embodiments, the offer may be based on geolocation information associated with the user's mobile device and a location of the merchant in the geographical area. For example, the transmitted offer may be associated with a merchant located closest to the mobile device. The offer may also be based on account information (e.g., transaction history during a predetermined period) associated with the user.

As used herein, geolocation information includes global positioning information. Global positioning information may include any information collected from methods, systems, apparatus, computer programs, or the like, involving locating a user's position relative to satellites, fixed locations, beacons, transmitters, the apparatus described herein, or the like. In some instances, global positioning information may be collected from a global positioning system (GPS) device, such as a navigation system. Such a navigation system may be, but is not limited to, hardware and/or software that is part of a mobile phone, smartphone, personal digital assistant (PDA), automobile, watch, tablet, portable computing device, or a commercially available personal navigation system. The amount, nature and type of the global positioning information that is collected may depend on the amount of information that the user has authorized the apparatus to collect or capture. In some embodiments, the global positioning information will be snapshots of the user's location at different times. For example, a snapshot of the user's location may be collected each time the GPS software, navigation system or application is activated. As another example, a snapshot of the user's location may be collected each time a user is located within the premises of a merchant or within a predetermined distance of a merchant or within the geographical area. As another example, a snapshot of the user's location may be collected each time a user executes a transaction at a merchant (e.g., via the user's mobile device). The geolocation information may also include the destination entered by the user, recent searches for locations or merchants, attractions, addresses, or the like. In other instances, the geolocation information may be a route (e.g., a route to a particular merchant) being provided to the user, including destination, route, alternate routes, anticipated time of arrival, or the like. In other embodiments, geolocation information may comprise a network location associated with a user (e.g., an Internet Protocol (IP) address, a device address, a location of a telecommunication tower located close to or closest to or within a predetermined distance from the user's device, or the like). In some embodiments, a user may need to register the user's mobile device with an entity associated with the apparatus in order to enable the apparatus described herein to capture geolocation information associated with the mobile device. In some embodiments, the geolocation comprises a location of a mobile device in relation to a beacon or other computing device located in the geographical area or outside the geographical area.

Geolocation information may or may not be associated with transaction information. For example, a user's geolocation information may be captured when the user executes a transaction at a merchant within the geographical area. The geolocation information may either be transmitted directly via the mobile device or may be transmitted via the merchant's system or terminal. As another example, a user's geolocation information may be captured based on the user visiting the merchant's premises (or being located within a predetermined distance of the merchant's premises) without actually executing a transaction at the merchant's premises. Therefore, when a user is located within the premises of a merchant or is located a predetermined distance from the merchant's premises, the user's mobile device transmits geolocation information associated with the user's mobile device to an apparatus (e.g., a server). As used herein, the merchant's premises refers to a physical area where the merchant sells goods or services. In other embodiments, the apparatus periodically pings the user's mobile device and receives geolocation information associated with the user's mobile device. In still other embodiments, the user's mobile device transmits geolocation information associated with the user's mobile device when the user executes a purchase transaction at a merchant. In still other embodiments, geolocation information associated with the merchant or the user's mobile device is stored with other transaction details associated with a transaction. The geolocation information may be stored in a database.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant. In some embodiments, an entity may be associated with a geographical area. In some embodiments, the “user” may be a customer (e.g., an account holder or a person who has an account (e.g., banking account, credit account, or the like) at the entity). In other embodiments, the user may not have an account at the entity.

Referring now to FIG. 2, FIG. 2 presents an exemplary block diagram of the system environment 200 for implementing any of the process flows described herein, in accordance with embodiments of the present invention. As illustrated, the system environment 200 includes a network 210, a system 230, and a user input system 240. Also shown in FIG. 2 is a user 245 of the user input system 240. The user input system 240 may be a mobile device (e.g., a portable mobile communication device) described herein. The user 245 may be a person who uses the user input system 240 to execute a user application 247. The system 230 may be a computing device (e.g., a check-in terminal, a check-out terminal, a server, or the like) associated with the geographical area. The user application 247 and/or the system application 237 may incorporate one or more parts of the process flow 100 or any other function described herein. The user 245 may use the user input system 240 to perform the various processes described herein. The system 230 may enable the various processes described herein. The user application 247 may be used by the user 245 to execute a purchase transaction, input payment preference information, provide permission to track geolocation information, or the like. Alternatively or additionally, the user application 247 may be configured to initiate transmission of geolocation information to the system 230. The system application 237 may be used to track geolocation information associated with the user input system 240, to enable a purchase transaction to be made, to identify the user 245 based on identification information associated with the user 245 or the user input system 240.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be a server, apparatus, or other computing device as described herein. The system may be associated with (e.g., managed by) at least one of a financial institution, a merchant, any other entity that may not be associated with the financial institution or the merchant, an acquirer, an issuer, a card network entity, a user of an account, or the like. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of any process flow described herein. Additionally, the system 230 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for making a payment associated with at least one merchant in a geographical area, the apparatus comprising:
a memory;
a processor; and
a module stored in the memory, executable by the processor, and configured to:
receive identification information from a mobile device when a user associated with the mobile device enters a geographical area;
receive geolocation information from the mobile device;
receive payment preference information;
determine, based on the geolocation information and the identification information, a purchase transaction being executed by the user in the geographical area;
store transaction information associated with the purchase transaction;
process the transaction information, based on the payment preference information, upon determining the mobile device is exiting or has exited the geographical area.

2. The apparatus of claim 1, wherein the module is further configured to receive the payment preference information from the mobile device or from a database accessible based on the identification information.

3. The apparatus of claim 1, wherein the module is further configured to receive the payment preference information prior to, during, or after the mobile device enters the geographical area.

4. The apparatus of claim 1, wherein the payment preference information comprises payment via at least one of a credit card, a debit card, a gift card, an electronic coupon, a prepaid card, or an electronic funds transfer.

5. The apparatus of claim 1, wherein the geolocation information comprises a geographical location of the mobile device.

6. The apparatus of claim 1, wherein the geolocation information comprises a network location of the mobile device.

7. The apparatus of claim 1, wherein the identification information comprises a device code or readable indicia associated with the mobile device.

8. The apparatus of claim 1, wherein the identification information comprises at least one of an image of the user, a fingerprint of the user, retinal information associated with the user, or biometric information associated with the user.

9. The apparatus of claim 1, wherein the identification information is received via a wireless transmission mechanism.

10. The apparatus of claim 1, wherein the geographical area comprises at least one merchant.

11. The apparatus of claim 1, wherein the purchase transaction is executed at a merchant terminal.

12. The apparatus of claim 11, wherein the identification information is displayed on the merchant terminal, and wherein the transaction information is associated with the identification information.

13. The apparatus of claim 12, wherein an agent at the merchant terminal selects an option to confirm the identification information.

14. The apparatus of claim 1, wherein the module is further configured to transmit an offer to the mobile device.

15. The apparatus of claim 1, wherein the mobile device comprises at least one of a mobile phone, a portable computing device, a tablet, or a watch.

16. The apparatus of claim 1, wherein the mobile device is configured to prompt the user to input an authentication credential in order to execute the purchase transaction.

17. The apparatus of claim 1, wherein the module is further configured to transmit to the mobile device a list of merchants in the geographical area and a location associated with each listed merchant.

18. The apparatus of claim 1, wherein the module is further configured to prompt the user to provide permission to receive geolocation information from the mobile device.

19. A method for making a payment associated with at least one merchant in a geographical area, the method comprising:
receiving identification information from a mobile device when the mobile device enters a geographical area;
receiving geolocation information from the mobile device;
receiving payment preference information;
determining, based on the geolocation information and the identification information, a purchase transaction being executed by a user of the mobile device in the geographical area;
storing transaction information associated with the purchase transaction;
processing the transaction information, based on the payment preference information, upon determining the mobile device is exiting or has exited the geographical area.

20. A computer program product for making a payment associated with at least one merchant in a geographical area, the computer program product comprising:
a non-transitory computer-readable medium comprising a set of codes for causing a computer to:
receive identification information from a mobile device when a user associated with the mobile device enters a geographical area;
receive geolocation information from the mobile device;
receive payment preference information;
determine, based on the geolocation information and the identification information, a purchase transaction being executed by a user of the mobile device in the geographical area;
store transaction information associated with the purchase transaction;
process the transaction information, based on the payment preference information, upon determining the mobile device is exiting or has exited the geographical area.
